(19) United States
(12) Patent Application Publication
(10) Pub. No.: US 2012/0316254 A1
(43) Pub. Date: Dec. 13, 2012

(54) COMPOSITE MEMORY FOAM AND USES THEREOF

(76) Inventor: Mario GÉLINAS, Saint-Barnabe-Nord (CA)

(21) Appl. No.: 13/486,109

(22) Filed: Jun. 1, 2012

Related U.S. Application Data
(60) Provisional application No. 61/495,444, filed on Jun. 10, 2011.

(51) Int. Cl. C08L 75/08

(52) U.S. Cl. 521/137

(57) ABSTRACT

The invention relates to composite memory foam and its uses in the manufacture of mattresses, pillows and other body supports. The invention also relates to a method of manufacturing mattresses, pillows and other body support from composite memory foam. The composite memory foam includes a polyurethane foam and granules of a polyurethane polymer embedded in the polyurethane foam.

### CROSS-REFERENCE TO RELATED APPLICATION

This application claims priority under 35USC §119(e) of U.S. provisional patent application No. 61/495,444 filed Jun. 6, 2011, the specification of which is hereby incorporated by reference.

### FIELD OF THE INVENTION

The invention relates to composite memory foam and its uses in the manufacture of mattresses, pillows and other body supports. The invention also relates to a method of manufacturing mattresses, pillows and other body support from composite memory foam.

### BACKGROUND OF THE INVENTION

Mattresses, pillows and other types of body supports are often manufactured from a pressure-relief material such as foam. A commonly known foam material is polyurethane foam, also known as memory foam or viscoelastic foam.

Polyurethane foam is produced by reaction of a polyisocyanate with a polyalchohol (i.e a polyol) in the presence of catalysts and additives. It is known in the art that the choice of the polyol blend and isocyanate greatly affects the properties of the polyurethane polymer. In some cases, the polymer foam may be too rigid to be comfortable or, alternatively, too soft to provide adequate support to the user.

Polyols are broadly classified as polyether polyols (i.e. polyols formed by base-catalyzed addition of propylene oxide (PO) or ethylene oxide (EO) onto an initiator containing a hydroxyl or an amine) or polyesther polyols (i.e. polyols polyesterification of a di-acid with glycols

Polyisocyanate are molecules with two or more isocyanate functional groups (i.e. R—(N=C═O)_{n>2}) and are typically classified as aliphatic or aromatic. The most commonly used aromatic isocyanates are diphenylmethane diisocyanate (MDI) and toluene diisocyanate (TDI), which include blends of molecules having a different number of isocyanate groups. Prior to forming the polyurethane foam, isocyanates can be modified to form a prepolymer by partially reacting them with a polyol. In such case, obtaining the polyurethane foam is carried out by a reaction of the prepolymer with the polyol.

Polyurethane foam provides relief of pressure points, which in turn improves blood circulation, diminishes tension points, and improves muscle relaxation and reduces stress on articulations of users, which makes its use desirable for the manufacture body supports. However, the use of polyurethane foam also has drawbacks. For instance, polyurethane foam tends to capture the body heat (i.e. not to dissipate heat adequately), thus making it uncomfortable, especially in warm days. To alleviate heat build-up, some have envisioned providing integrated ventilation channels allowing air to circulate and the mattresses to breath, thus improving heat dissipation. However, the presence of such integrated ventilation channel tends to affect the quality of the foam.

Another drawback associated with polyurethane foam is that its manufacture is associated with the use of non-renewable fossil fuels. With the growing demand of green products, memory foam can therefore rebut some customers. More recently, the use of natural oil polyols or biopolyols has been envisioned. Biopolyols are derived from vegetable oil such as soybean oil, peanut oil, canola oil (which all require chemical modification) and castor oil, (naturally occurring). However, because the nature and proportions of biopolyols in the polyol blend greatly affect the characteristics of the polyurethane foam, the use of biopolyols in the manufacture of mattresses and body supports still deserve attention.

The use of chemicals in the production of polyurethane mattresses and body supports is also required to improve the fire performance of the foam. Indeed, most jurisdictions have flameproof standards which apply to mattresses, beds, cushions and the like. For instance, the United States regulation requires all new mattresses to withstand a two-foot wide blowtorch open-flame test for 70 seconds. To meet these standards, mattresses and pillows manufacturers use fire retardants which are in most cases chemicals. While these compounds are efficient to improve fire performance, their use may in some instances be associated with health issues such as skin irritation. It is therefore desirable to minimize the use of such chemicals while maintaining the fireproof capabilities of the mattress.

### BRIEF SUMMARY OF THE INVENTION

The invention provides composite memory foam comprising polyurethane foam; and granules of a polyurethane polymer embedded in the polyurethane foam.

According to one aspect, the polyurethane foam is made from a first blend of polyols reacted with a first polyisocyanate. Typically, the first blend of polyols comprises a first blend of polyester polyols and a first blend of polyether polyols.

According to another aspect, the first blend of polyether polyols comprises soybean oil polyols. Preferably, the first blend of polyether polyols comprises between about 1% and about 20% soybean oil polyols, and more preferably between about 10% and about 15% soybean oil polyols and even more preferably about 15% soybean oil polyols.

According to yet another aspect, the first polyisocyanate is selected from the group consisting of aromatic isocyanate and aliphatic isocyanate. Preferably, the aromatic isocyanate is selected from the group consisting of diphenylmethane diisocyanate (MDI) and toluene diisocyanate (TDI).

According to a further aspect, the first blend of polyols is a blend of polyether polyols and the first polyisocyanate is diphenylmethane diisocyanate (MDI).

According to another aspect, the granules of a polyurethane polymer comprise granules of a polyurethane elastomer.

According to yet another aspect, the polyurethane foam and the polyurethane elastomer each have a density, the density of the polyurethane foam being lower than the density of the polyurethane elastomer.

According to an additional aspect, the polyurethane elastomer comprises a second blend of polyols reacted with a second polyisocyanate.

According to a further aspect, the second blend of polyols comprises a second blend of polyester polyols and a second blend of polyether polyols.

According to yet a further aspect, the second blend of polyether polyols comprises soybean oil polyols. In this aspect, the second blend of polyether polyols preferably comprises up to about 90% soybean oil polyols.

According to an additional aspect, the second polyisocyanate is selected from the group consisting of aromatic isocyanate and aliphatic isocyanate. Preferably, the aromatic isocyanate is selected from the group consisting of diphenylmethane diisocyanate (MDI) and toluene diisocyanate (TDI).

According to another aspect, the second blend of polyols is a blend of polyether polyols and the second polyisocyanate is diphenylmethane diisocyanate (MDI).

According to yet another aspect, the composite foam comprises between about 1% (w/w) and about 25% (w/w) granules of the polyurethane polymer, and preferably between about 2.5% (w/w) and about 20% (w/w) granules of the second polyurethane polymer and more preferably between about 10% (w/w) and 15% (w/w) of the second polyurethane polymer.

The invention further provides a composite memory foam comprising:
a. A polyurethane foam comprising a first blend of polyether polyols reacted with diphenylmethane diisocyanate (MDI), the polyurethane foam having a first density;
b. Granules of a polyurethane elastomer embedded in the polyurethane foam, the polyurethane elastomer comprising a second blend of polyether polyols reacted with diphenylmethane diisocyanate (MDI), the polyurethane elastomer having a second density, the first density being lower than the second density.

According to one aspect, the composite foam comprises between about 1% (w/w) and about 25% (w/w) granules of the polyurethane elastomer, and preferably between about 2.5% (w/w) and about 20% (w/w) granules of the polyurethane elastomer and more preferably between about 10% (w/w) and about 15% (w/w) granules of the polyurethane elastomer.

The invention also provides the use of composite memory foam in the manufacture of a body support. According to one aspect, the body support is selected from the group consisting of a mattress, a mattress layer, a mattress topper, a pillow and a cushion.

The invention further provides a method of manufacturing a composite memory foam, the method comprising:
a. Providing granules of a polyurethane polymer;
b. Providing a polyol;
c. Providing a polyisocyanate;
d. Mixing the granules of the polyurethane polymer, the polyol and the polyisocyanate to obtain a polyurethane mixture; and
e. Allowing the polyurethane mixture to expand to form the composite memory foam.

The invention also provides the use of soybean oil in the manufacture of a body support made of composite memory foam.

### BRIEF DESCRIPTION OF THE DRAWINGS

In order that the invention may be readily understood, embodiments of the invention are illustrated by way of example in the accompanying drawings.

FIG. 1 is a schematic view of a composite memory foam in accordance with one embodiment of the present invention;

FIG. 2 is a sectional view of a mattress in accordance with one embodiment of the present invention;

FIG. 3 is a schematic view of a method of manufacturing a mattress in accordance with one embodiment of the present invention;

FIG. 4 is a perspective view of a hybrid mattress having an innerspring base layer and a composite foam layer in accordance with one embodiment of the present invention;

FIG. 5 is a perspective view of a pillow in accordance with one embodiment of the present invention; and

FIG. 6 is a schematic view of a method of manufacturing a pillow in accordance with one embodiment of the present invention.

Further details of the invention and its advantages will be apparent from the detailed description included below.

### DETAILED DESCRIPTION OF PREFERRED EMBODIMENTS

In the following description of the embodiments, references to the accompanying drawings are by way of illustration of an example by which the invention may be practiced. It will be understood that other embodiments may be made without departing from the scope of the invention disclosed.

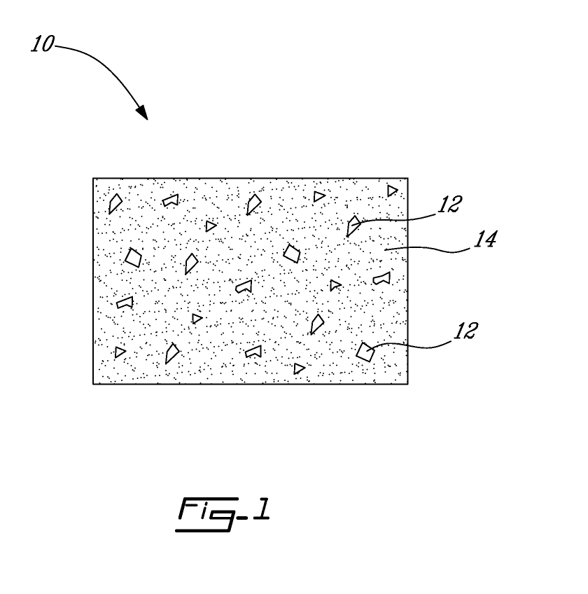

In one embodiment, a composite memory foam 10 (i.e. a composite viscoelastic foam) is provided (best shown in FIG. 1). The composite memory foam 10 comprises granules of a substantially firm polyurethane polymer 12 (e.g. granules of a polyurethane elastomer) embedded in a softer polyurethane foam matrix 14.

In one embodiment, the composite memory foam 10 comprises the polyurethane foam (i.e. the foam matrix) 14 and the granules of polyurethane polymer or elastomer 12 embedded in the foam matrix 14. A person skilled in the art will appreciate that the characteristics of the composite memory foam 10, such as the matrix density, the proportion and the size of polymer granules can be adapted to particular uses. For instance, mattresses or pillows having different firmness (i.e. matrix density) could be manufactured to meet customers' requirements.

In one embodiment, the foam matrix 14 is obtained by reacting a blend of liquid polyether polyols with liquid diphenylmethane diisocyanate (MDI), which typically, comprises a blend of three isomers, namely 4,4′-MDI, 2,4′-MDI, and 2,2′-MDI. In this embodiment, the blend of liquid polyether polyols may comprise a mixture of ethoxylated and propoxylated polyols having a functionality (i.e. a “reticulation”) between 2 and 3, as well as a modified oligomeric vegetable oil polyol. A person skilled in the art will appreciate that the foam matrix 10 could be obtained by mixing other types of polyols. For instance, one may opt for polyester polyols instead of polyether polyols or, alternatively, for a blend of polyester and polyether polyols.

According to one embodiment, the polyol blend may comprise soybean oil polyols. In this embodiment, the presence of natural soybean oil polyols reduces the need for chemical polyols, which in turn provides a “greener” foam matrix. Further, it has been found that soybean oil polyols have intrinsic fire-resistant properties and therefore their presence in the polyurethane matrix contributes to reduce the need for chemical fire-retardants. Accordingly, in one embodiment, the polyol blend comprises, prior to polymerization, between about 1% and about 20% (w/w) soybean oil polyols, and typically between about 10% and about 15% (w/w) soybean oil polyols and more typically about 15%. It has been found that a concentration of about 9% to 10% (w/w) provides an adequate firmness to a polyurethane matrix aimed at the mattress market, while contributing to meet fireproof standards.

In another embodiment, the polyol blend may comprise any vegetal polyol or combination of vegetal polyols. The vegetal polyol may replace, fully or in part, or supplement the soybean oil polyol.

In another embodiment, the polyol blend may comprise any vegetal oil or combination of vegetal oils. The polyol blend may comprise, prior to polymerization, between about 1% and about 10% (w/w) vegetal oil, and typically about 3%.

While in this embodiment liquid diphenylmethane diisocyanate (MDI) is used, a person skilled in the art will appreciate that a suitable memory foam could also be obtained using another aromatic polyisocyanate such as, for instance toluene diisocyanate (TDI) (i.e. a mixture of the 2,4- and 2,6-diisocyanatotoluene isomers), or a MDI/TDI mixture, or using an aliphatic polyisocyanate. The terms “polyisocyanate” and “isocyanate” are interchangeably used herein to mean compounds with isocyanate groups capable of forming polyurethane foam and include a polyisocyanate prepolymer (i.e. isocyanates by partially reacting them with a polyol).

A person skilled in the art will also appreciate that other additives such as catalysts can be added to the mixture. For instance, standard amine catalysts (1% to 2%) and a standard silicone base surfactant (1.5% to 3.0%) can be used.

In a typical embodiment, the foam matrix for use in the manufacture of mattresses has a density ranging from about 2 lb/ft³ to about 7 lb/ft³ and typically between about 3 lb/ft³ to about 6 lb/ft³ and an isocyanate index ranging from 0.60 to 1.10 and typically from about 0.70 to 0.90.

Embedded in the matrix 14 are the granules 12. The terms “granules” or “particles” are used interchangeably herein and are intended to mean small pieces of a polyurethane polymer. A person skilled in the art will appreciate that any other suitable granular material could be used and that the shape of the granules can be regular or irregular and, that the granules can comprise a blend of granules having irregular shapes and sizes or, alternatively, be granules having constant shapes and/or size. The person skilled in the art will further appreciate that the granule, their size, uniformity, as well as their relative amount in the composite memory foam will be selected based upon the desired characteristics of the foam. In one embodiment, the average size of the granules ranges from about 0.1 mm to about 7 mm, and preferably between about 0.2 mm and 1.2 mm. According to one example, the granules of polyurethane polymer are manufactured by a reaction of a blend of polyether polyols with diphenylmethane diisocyanate (MDI) to form a sheet or a mat of polyurethane polymer which is then broken down into granules of the desired size using a granulator. In an alternate embodiment, the blend of polyols comprises soybean oil polyols.

The person skilled in the art will further appreciate that the concentration or proportion of polymer particles in the composite memory foam can vary depending on the use for which it is intended. For instance, in the manufacture of mattresses, the polymer granules may represent about 15% (w/w) of the total weight of the composite foam liquid mixture (i.e. blend of polyols and isocyanates prior to reaction—or about 10% w/w of the reacted polyurethane foam) while a foam used in the manufacture of pillows would comprise about 2.5% particles (w/w). In other uses, the amount of polymer granules may be lower or higher and therefore, in accordance with one embodiment, the granule content vary from about 1% to about 15% (w/w) of the weight of the liquid mixture for producing a composite foam, and typically about 15% (w/w).

In accordance to one embodiment, the granules 12 have a firmness ranging from about 30 to about 80 on the Shore A scale and preferably a firmness of about 40 on the Shore A scale.

According to a further embodiment, the polymer granules 12 are granules of a polymer elastomer having a density higher than the polymer foam of the matrix. In this embodiment, the polymer granules are made from a blend of polyols reacted with a polyisocyanate. The blend of polyols typically comprises a blend of polyether polyols. Preferably, the granules are obtained by reacting a blend of liquid polyether polyols with liquid diphenylmethane diisocyanate (MDI), which typically, comprises a blend of three isomers, namely 4,4′-MDI, 2,4′-MDI, and 2,2′-MDI. In this embodiment, the blend of liquid polyether polyols comprises a blend of ethoxylated and propoxylated diols and triols. It has been found that using a similar formula for both the polymer granules and the polyurethane matrix (i.e. polyether polyols and liquid MDI) tends to increase the adherence or bounding between the two materials, thereby preventing unwanted separation of the granules from the matrix. A person skilled in the art will nevertheless appreciate that the granules could be obtained by mixing other types of polyols such as polyester polyols or a blend of polyester and polyether polyols and that the general formula of polymer granules and the matrix need not to be similar. While in this embodiment liquid diphenylmethane diisocyanate (MDI) is used, a person skilled in the art will appreciate that granules could also be obtained using another aromatic polyisocyanate, an aliphatic polyisocyanate, a toluene diisocyanate (TDI) isocyanate or a mixture of MDI and TDI.

According to one embodiment, the polyol blend for obtaining the polymer granules may comprise soybean oil polyols. Soybean oil polyols can be used up to 90% of the formulation of the polyurethane elastomer. Further standard additives such as amine catalyst (e.g. less than 1%), dye (e.g. less than 1%) and defoamer (e.g. less than 1%) can also be used.

According to the above embodiments, the polymer granules 12 form “heat channels” in the composite matrix 14 to increase the thermal conductivity of the composite foam 10, thereby reducing heat build-up therein. This characteristic of the composite memory foam 10 may be particularly advantageous for applications relating to body support such as, for instance, the manufacture of mattresses, pillows, cushions, and the like. Using a mattress as example, the heat of a user laid down on his bed is absorbed by the polyurethane foam. However, because the memory foam 10 is partially compressed by the weight of the user's body, the granules or particles of polymer 12 come closer to one another, therefore enhancing dissipation of the heat transferred from the user's body to the mattress. The presence of the polyurethane polymer particles 12 in the matrix 14 thus tends to enhance the user's comfort. For instance, tests carried out on different 2-inch thick composite foams showed that the thermal conductivity of the foam is 0.277 Btu. in./ft².h.F while the thermal conductivity is 0.296 Btu. in./ft².h.F and 0.304 Btu. in./ft².h. F with 10% and 15% granules, respectively.

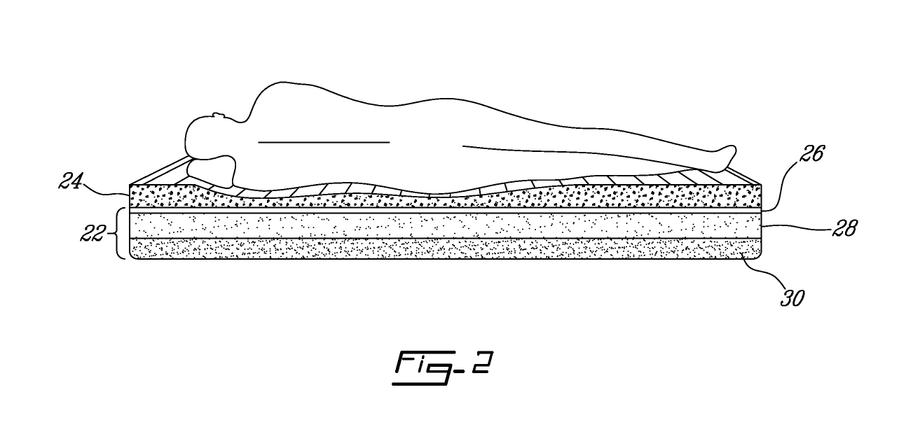

Having described composite memory foams in accordance with various embodiments, a method for manufacturing the same will now be described by way of examples. With reference to FIG. 2, one example of composite foam for use in the manufacture of a mattress 20 is provided. In this embodiment, the mattress 20 comprises a base layer of standard memory foam 22 and a top layer 24 of composite foam. In this embodiment, the base layer of standard foam 22 has a thickness ranging from about 0.5 inches to about 50 inches (typically between about 5.5 and 8 inches) and comprise several sub-layers, 26, 28 and 30 each of the sub-layers of memory foam 26, 28 and 30 having different characteristics such as firmness for instance. In an alternate embodiment, the layer of standard memory foam 22 could consist in a single, unitary layer of memory foam.

Glued on top of the base layer 22 is the composite foam layer 24. The composite foam layer is preferably adhered to the base layer using an adhesive such as, for instance a drying adhesive (e.g. water-based glue), a hot adhesive, or a contact adhesive. In this embodiment, the composite foam layer comprises a polyurethane matrix in which are embedded granules or particles of a polyurethane polymer and generally corresponds to the composite foam 10 described hereinabove. In an alternate embodiment, the composite foam layer 24 could be placed on top of the base layer 22 without being glued.

An insulator layer which separates the base layer 22 from the top layer 24 can be added.

A quilt can be added on top of the composite foam layer 24. It can be manufactured in varying degrees of firmness.

A protective fabric cover is typically added. It encases the mattress and is often called ticking. It can come in a wide variety of colors and styles. Mattress fabrics can be knits, damask, printed woven materials, inexpensive nonwoven materials, stretchy knit fabrics, etc. The ticking can be made with polyester yarns with or without rayon, cotton, silk, wool or other natural yarns. The mattress can be covered with any number of different fabrics for the top panel (the sleeping surface), the borders of the mattress, the side panels and the reverse side of the mattress.

As will be readily understood, the composite foam layer 24 could be manufactured to be sold independently of the mattress itself. This is often referred to as a “mattress topper”. A composite foam mattress topper is a composite foam layer 24 as described above which is simply placed on top of the base layer 22 of any mattress. It typically has a thickness of from about 1 inch to about 5 inches, more typically from about 2 to about 4 inches. It can be covered by a protective fabric cover.

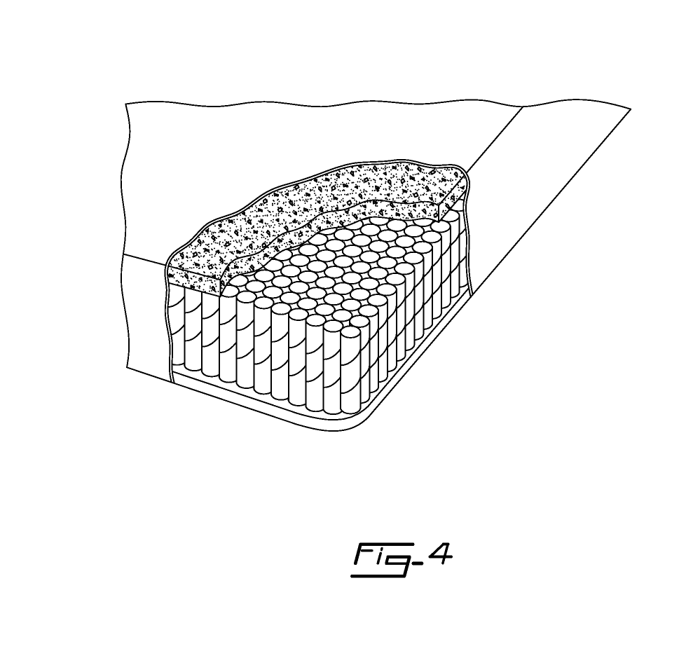

With reference to FIG. 4, another example of the use of composite foam in the manufacture of a mattress is provided. This mattress is an innerspring mattress with a composite foam top layer and can therefore be referred to as a “hybrid mattress”.

In this embodiment, the mattress comprises a base layer of innerspring. The innerspring base layer can include pocket steel coil springs, individually pocketed steel coil springs, steel coil springs, etc. As will be readily understood, the gauge of the coils gives an indication of firmness and support. Innerspring base layers can typically comprise 12.5-gauge (1.94 mm) to 14-gauge (1.63 mm) diameter coils. As will also be readily understood, the type of coil (Bonnell coil, Marshall coil, offset coil, continuous coil), the coil count (for example between 400 and 800) and the number of working turns also give an indication of firmness and support as well as integrity, resiliency and overall quality of the innerspring mattress. The person skilled in the art will further appreciate that the specific configuration of the innerspring base layer will be selected based upon the desired characteristics of the hybrid mattress. In this embodiment, the base layer of coil springs has a thickness ranging from about 0.5 inches to about 50 inches, typically between about 4 and about 12 inches. In an alternate embodiment, more than one layer of coils could be used.

The innerspring base layer can be covered by a layer of felt, for example by inserting a felt mattress pad between the innerspring base layer and the composite foam top layer.

Glued on top of the base layer (or the felt mattress pad) is the composite foam layer. The composite foam layer is preferably adhered to the base layer using an adhesive such as, for instance a drying adhesive (e.g. a water-based glue), a hot adhesive, or a contact adhesive. In this embodiment, the composite foam layer comprises a polyurethane matrix in which are embedded granules or particles of a polyurethane polymer and generally corresponds to the composite foam described hereinabove. In an alternate embodiment, the composite foam layer could be placed on top of the base layer without being glued.

Other items could be manufactured using the composite foam. Car seats, couch cushions, chair cushions, etc. could be manufactured with a composite foam layer.

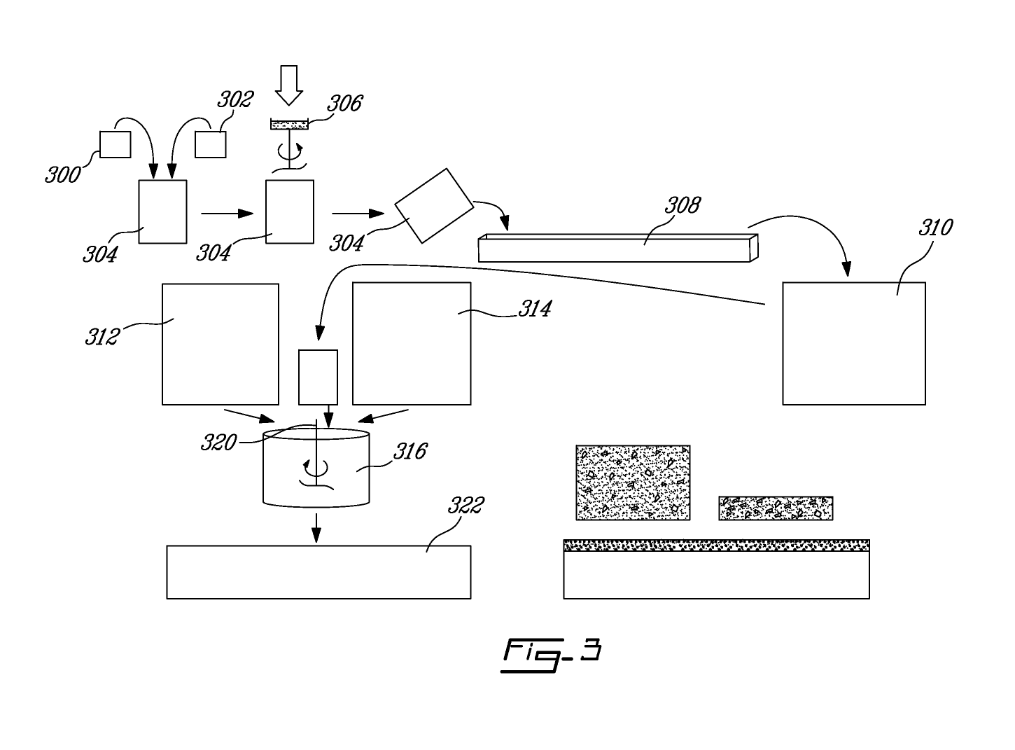

With reference to FIG. 3, the composite layer 24 is manufactured by preparing the polymer granules which are then mixed with the liquid components of the polymer matrix. More specifically, the polymer granules are prepared by reacting liquid diphenylmethane diisocyanate (MDI) contained in a first tank 300 with a polyether polyol blend contained in a second tank 302. Briefly stated, MDI and polyol blend and other additives are poured in a container 304 and are mixed using a mixer 306. After having thoroughly mixed the liquid components, the polyurethane polymer is poured in a generally rectangular mold 308. The mold could be a closed mold. The liquid components are allowed to polymerize to form a generally rectangular mat or sheet of polyurethane polymer. The mat or sheet of polyurethane polymer is then broken down into granules using a granulator 310 and the granules of polyurethane polymer are stored for subsequent use.

The granules could alternatively be prepared using a low- or high-pressure polyurethane injection machine.

At the time of preparing the composite layer 24, the liquid components of the polyurethane matrix, namely the liquid diphenylmethane diisocyanate (MDI) contained in a third tank 312 and a polyether polyol blend contained in a fourth tank 314, are mixed with a given amount of polymer granules in a container 316, using a mixer 320. In one embodiment, about 10% (w/w) polymer granules are mixed with the liquid components. The mix obtained is then poured in a generally rectangular mold 322 having the width and length corresponding to those of the composite layer to be obtained. The liquid components of the composite layer 24 are then allowed to expand for a sufficient period of time. Upon completion of expansion, the foam layer 24 is unmolded and adhered to the standard memory foam layer 22 using techniques known in the art.

The composite foam could alternatively be manufactured using a Continuous Foam Production Machine with the addition or pulverization of granules in the matrix. The continuous foam is then cut according to the required dimensions for the product being manufactured.

The person skilled in the art will appreciate that it may be practically and economically advantageous to prepare several foam layers simultaneously. Accordingly, in one embodiment, a master composite foam layer having a given thickness may be produced as described above and be subsequently sliced into a plurality of thinner composite foam layers 24. In a further embodiment, instead of gluing or adhering the composite foam layer 24 to a layer of standard memory foam as described above, one may opt for using the foam layer 24 separately, such as for use as a mattress topper.

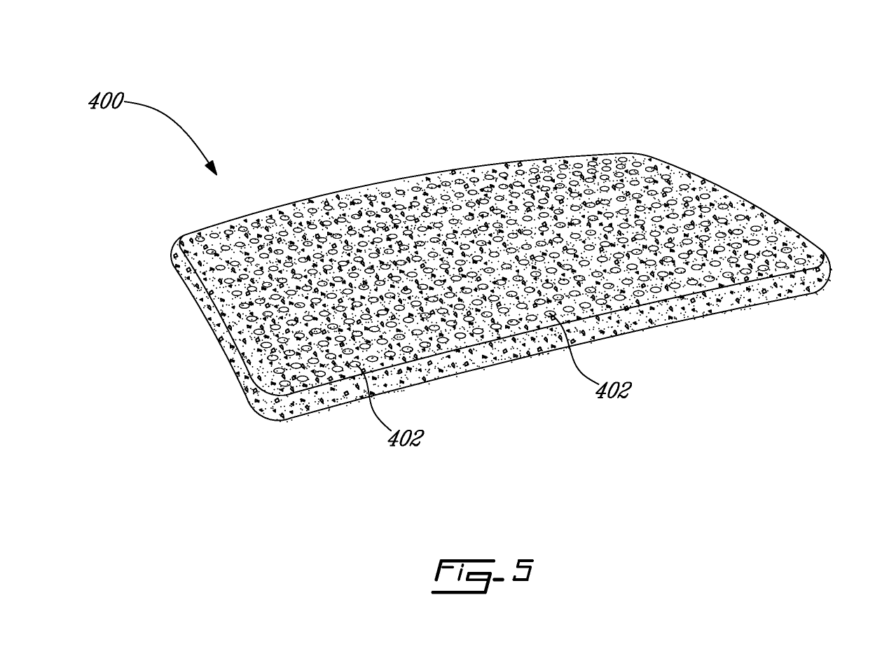

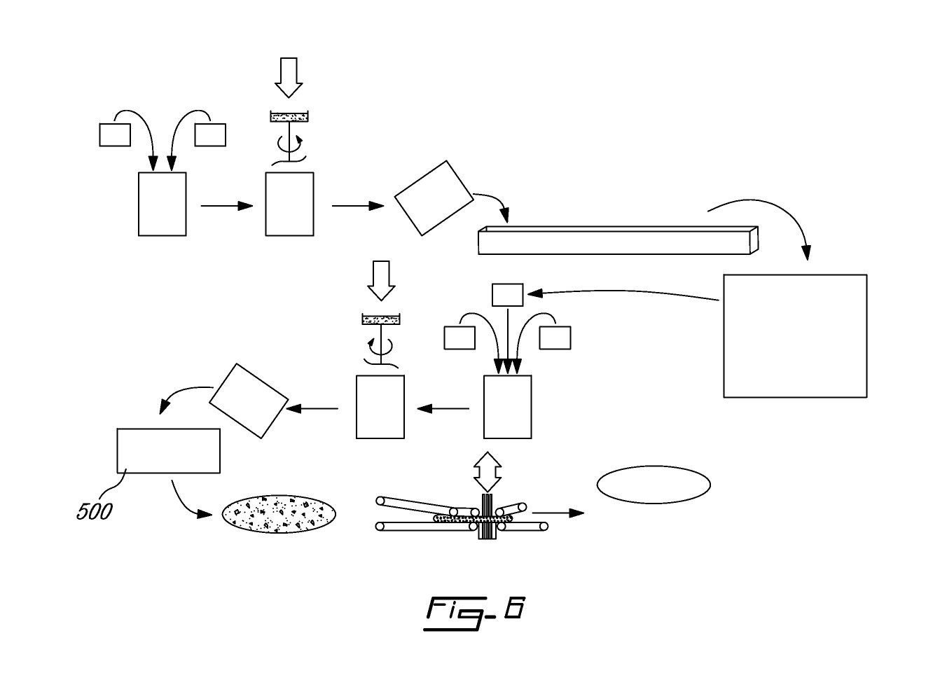

In another example, shown in FIGS. 5 and 6, the composite polyurethane foam is used in the manufacture of a pillow. In this example, the composite foam is manufactured as described for layer 24, except that the granule content may be lower (e.g. 2.5% (w/w) of the liquid content of the polyurethane mixture). In this embodiment, the mixture is poured and allowed to expand in a pillow mold 500 having a generally oblong or oval cross-section. Upon completion of the composite polyurethane, the pillow is unmolded. In one embodiment, heat channels 402 in the form of perforations extending from one side of the pillow to the other can be defined by compressing the pillow and running the same in a punch press. In this embodiment, the heat channels provide enhanced heat dissipation which, together with the granules, contribute to avoid heat build-up in the pillow.

A person skilled in the art will appreciate that the composite foam of the present invention may have multiple uses and that the examples above are not exhaustive. Although the above description relates to a specific preferred embodiment as presently contemplated by the inventor, it will be understood that the invention in its broad aspect includes mechanical and functional equivalents of the elements described herein.

1. A composite memory foam comprising:
(a) A polyurethane foam; and
(b) Granules of a polyurethane polymer embedded in said polyurethane foam.

2. The composite memory foam according to claim 1, wherein said polyurethane foam is made from a first blend of polyols reacted with a first polyisocyanate.

3. The composite memory foam according to claim 2, wherein said first blend of polyols comprises a first blend of polyester polyols and a first blend of polyether polyols.

4. The composite memory foam according to claim 3, wherein said first blend of polyether polyols comprises soybean oil polyols.

5. The composite memory foam according to claim 4, wherein said first blend of polyether polyols comprises between about 1% and about 20% soybean oil polyols.

6. The composite memory foam according to claim 1, wherein said first polyisocyanate is selected from the group consisting of aromatic isocyanate and aliphatic isocyanate.

7. The composite memory foam according to claim 6, wherein said aromatic isocyanate is selected from the group consisting of diphenylmethane diisocyanate (MDI) and toluene diisocyanate (TDI).

8. The composite memory foam according to claim 2, wherein said first blend of polyols is a blend of polyether polyols and said first polyisocyanate is diphenylmethane diisocyanate (MDI).

9. The composite foam according to claim 1, wherein said granules of a polyurethane polymer comprise granules of a polyurethane elastomer.

10. The composite foam according to claim 9, wherein said polyurethane foam and said polyurethane elastomer each have a density, the density of said polyurethane foam being lower than the density of said polyurethane elastomer.

11. The composite foam according to claim 9, wherein said polyurethane elastomer comprises a second blend of polyols reacted with a second polyisocyanate.

12. The composite memory foam according to claim 11, wherein said second blend of polyols comprises a second blend of polyester polyols and a second blend of polyether polyols.

13. The composite memory foam according to claim 12, wherein said second blend of polyether polyols comprises soybean oil polyols.

14. The composite memory foam according to claim 13, wherein said second blend of polyether polyols comprises up to about 90% soybean oil polyols.

15. The composite memory foam according to claim 11, wherein said second polyisocyanate is selected from the group consisting of aromatic isocyanate and aliphatic isocyanate.

16. The composite memory foam according to claim 15, wherein said aromatic isocyanate is selected from the group consisting of diphenylmethane diisocyanate (MDI) and toluene diisocyanate (TDI).

17. The composite memory foam according to claim 11, wherein said second blend of polyols is a blend of polyether polyols and said second polyisocyanate is diphenylmethane diisocyanate (MDI).

18. The composite memory foam according to claim 1, wherein said composite foam comprises between about 1% (w/w) and about 25% (w/w) granules of said polyurethane polymer.

19. A composite memory foam comprising:
(a) A polyurethane foam comprising a first blend of polyether polyols reacted with diphenylmethane diisocyanate (MDI), said polyurethane foam having a first density;
(b) Granules of a polyurethane elastomer embedded in said polyurethane foam, said polyurethane elastomer comprising a second blend of polyether polyols reacted with diphenylmethane diisocyanate (MDI), said polyurethane elastomer having a second density, said first density being lower than said second density.

20. The composite foam according to claim 19, wherein said composite foam comprises between about 1% (w/w) and about 25% (w/w) granules of said polyurethane elastomer.

21. A method of manufacturing a composite memory foam, said method comprising:
(a) Providing granules of a polyurethane polymer;
(b) Providing a polyol;
(c) Providing a polyisocyanate;
(d) Mixing said granules of said polyurethane polymer, said polyol and said polyisocyanate to obtain a polyurethane mixture; and
(e) Allowing said polyurethane mixture to expand to form said composite memory foam.

22. Use of composite memory foam according to claim 1 in the manufacture of a body support.

23. Use according to claim 22 wherein said body support is selected from the group consisting of a mattress, a mattress layer, a mattress topper, a pillow and a cushion.

24. Use of soybean oil in the manufacture of a body support made of a composite memory foam according to claim 1.
